(19) United States
(12) Patent Application Publication
(10) Pub. No.: US 2008/0163696 A1
(43) Pub. Date: Jul. 10, 2008

(54) Flow Meter

(75) Inventors: Paul Crudge, North Wales (GB); John Gillen, North Wales (GB)

Correspondence Address: TAYLOR RUSSELL & RUSSELL, P.C., 4807 SPICEWOOD SPRINGS ROAD, BUILDING TWO SUITE 250, AUSTIN, TX, 78759, US

(73) Assignee: Paul CRUDGE, Deeside, North Wales (GB)

(21) Appl. No.: 11/571,107

(22) PCT Filed: Jun. 23, 2005
(86) PCT No.: PCT/GB2005/002467

§ 371 Date: Nov. 26, 2007

(30) Foreign Application Priority Data
Jun. 24, 2004 (GB) 041477.6

(51) Int. Cl. G01F 1/00

(52) U.S. Cl. 73/861

(57) ABSTRACT

A volume flow meter for measuring volume flow of a multiphase fluid, particularly milk in a milking installation, is disclosed. The flow meter comprises a sensor chamber and a feed duct for conveying fluid to the sensor chamber. The feed duct is shaped such that the fluid leaving the feed duct has a character that is more nearly in a pure liquid phase than the fluid entering the feed duct. For example, this may be achieved by forming the feed duct into the shape of an inverted ‘U’. An assessment of total volume flow is made by combining measurements of presence or absence of liquid in multiple regions of the cross-section of the sensor chamber. Optionally, there may be a second sensor chamber disposed upstream of the feed duct.

This invention relates to a flow meter. It has particular application to a flow meter that can measure volume flow of multiphase fluid in a pipe where that flow is turbulent and where the flow does not always fill the pipe. It has particular, but not exclusive, application to measuring volume-flow of milk in a milking installation.

Flow of milk in the pipes of a milking parlour is notoriously difficult to measure. The flow is turbulent, rapidly varying in direction, volume and is multiphase (that is to say, it has components of greatly differing speeds). Moreover, the liquid that flows in the pipe is accompanied by a large amount of air, such that the milk fills a rapidly varying fraction of the cross-section of the pipe and is of variable density. The flow also occurs in slugs—periods if high flow rate in which the flow almost fills the pipe, separated by periods in which the flow is greatly reduced.

In GB2391304 in the name of the present applicant, a flow meter was proposed that used multiple measurement techniques to provide an instantaneous estimate of the amount of a flow pipe occupied by flowing liquid, and this is combined with an estimate of the speed of the flow to derive an estimate of volume flow. While this system has proven to be very accurate, in some circumstances it can be difficult to calibrate and the multiple sensors required mean that it is of a cost that is excessive for some applications.

An aim of this invention is to provide a sensor that is at least as accurate as that disclosed in GB2391304 at reduced complexity and therefore potentially reduced cost.

Therefore, from a first aspect, this invention provides a volume flow meter for measuring volume flow of a multiphase fluid comprising:

a sensor chamber;

a feed duct for conveying fluid to the sensor chamber;

wherein the feed duct is shaped to condition the flow such that, in the fluid leaving the feed duct, components of flow at distinct speeds are more spatially distributed within the sensor chamber.

The principal of operation of a meter embodying the invention is to reduce the multiphase nature of the fluid prior to attempting to measure its flow. Measurement of fluid in such a state is normally more predictable and less error-prone than measuring a highly multiphase flow. Ideally, components of flow of different speeds are completely separated within the cross-sectional area of the sensor chamber, however, it is likely that this ideal will only be approached, rather than achieved.

For example, the feed duct may be shaped as a U, and this may be disposed in a vertical plane with the convex outer surface uppermost. From the feed duct, fluid may then pass downwardly into a generally vertical sensor chamber. The effect of this arrangement is to condition the flow such that slower components tend to be grouped on the inside of the curve of the duct while high-speed components are grouped towards the outside of the curve.

In preferred embodiments, reduction in the multiphase nature of the flow is further enhanced by causing the flow to follow a curved path, the centripetal force applied by the wall of the duct to the flow causing the fluid to compress against the outer wall of the duct. The effect of this is to separate the liquid from the air entrained within it.

Embodiments of the invention include a metering arrangement that detects and measures fluid flow through the sensor chamber. For example, the metering arrangement may operate to detect flow using optical detection means. However, alternative embodiments may use other types of metering arrangement using, for example, electromagnetic, electrostatic or radio-frequency detection systems. In such embodiments, the measuring chamber may be formed of a transparent material. Such a metering arrangement may operate by directing radiation through the tube and detecting reflection of radiation from the fluid within the tube. For example, the principal mode of reflection may be multi-layered reflection from liquid within the sensor chamber.

Embodiments of this aspect of the invention may include a primary and a secondary sensor chamber, fluid flowing through the meter first passing through the secondary sensor chamber, then into the feed duct, and then into the primary sensor chamber.

From a second aspect, this invention provides a volume flow meter for measuring volume flow of a multiphase fluid comprising a primary sensor array and a secondary array chamber, the fluid to be measured passing through the secondary sensor array before passing through the primary sensor array, output from the first sensor array being analysed and the results of the analysis being used to influence operation of the primary sensor array.

For example, in sensors that are intended to measure flow that occurs in slugs, output from the secondary sensor array can be used to detect the imminent arrival of a slug, such that the primary sensor array can be configured to operate in a mode most suitable for measurement of flow in a high-flow conditions immediately prior to the arrival of a slug at the primary sensor array.

The secondary sensor array is operative to measure velocity of flow passing through it and/or to determine an estimate of the mass/volume ratio of fluid flowing through it. This information can be used to make predictions about the nature of the flow and thus improve the accuracy with which the primary sensor array can operate.

From a third aspect, this invention provides a method for calibration of a sensor array in which the array includes one or more emitters and one or more detectors, each detector being operative to measure radiation emitted by an emitter that has been reflected from flowing fluid, in which it is assumed that, during operation, the detectors will from-time-to-time receive an amount of reflected radiation corresponding to maximum flow in the pipe, the method comprising maintaining a tracking parameter that represents the maximal output from the detector as it changes with time.

The tracking parameter may be the instantaneous maximum output that has been observed in a measurement session. This can compensate for changes in output due to changes in the nature of the fluid flow that is being measured, and for changes in the performance of the emitters and detectors. Alternatively, it may represent an average of maxima, or it may ignore occasional excessively high readings so that it is not skewed by occasional anomalous values. This method has particular, but not exclusive, application to calibration of an optical sensor array.

In calibration of a sensor array for use in a milking installation, it has been found to be advantageous if the parameter is allowed only to rise (or remain steady), and not to fall. This can compensate for the known tendency for fat content of milk, and therefore its reflectivity, to increase during milking, while at the end of milking, the flow may fall to such an extent that maximal reflectivity is no longer encountered.

Embodiments of the invention will now be described in detail, by way of example, and with reference to the accompanying drawings, in which:

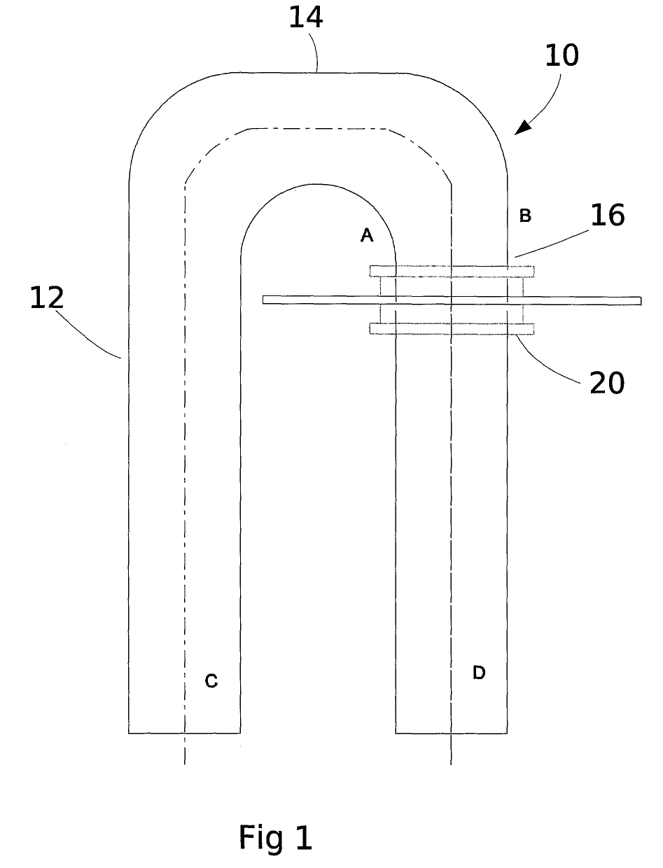

FIG. 1 is a cross-sectional view of a duct and measuring chamber of a flow meter being a first embodiment of the invention;

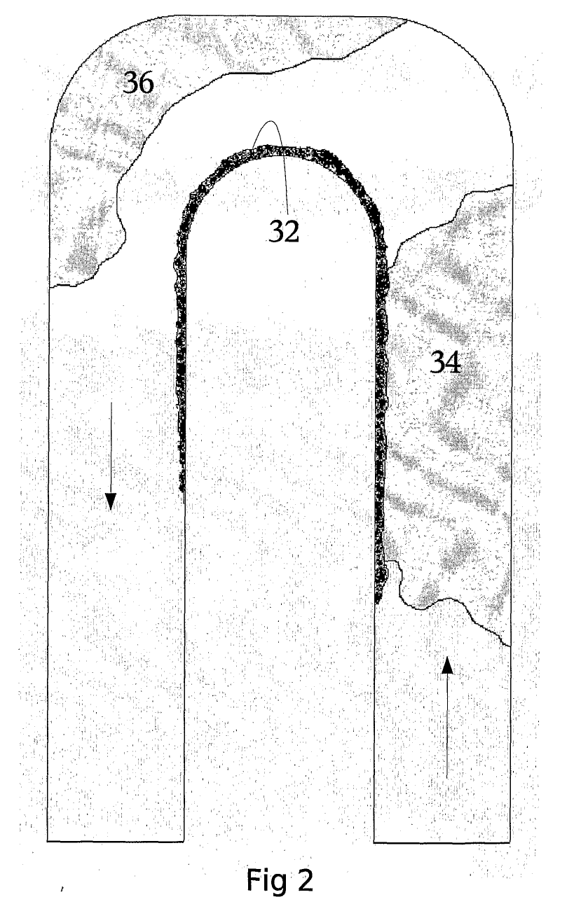

FIG. 2 illustrates the flow of a fluid through the duct and measuring chamber of FIG. 1;

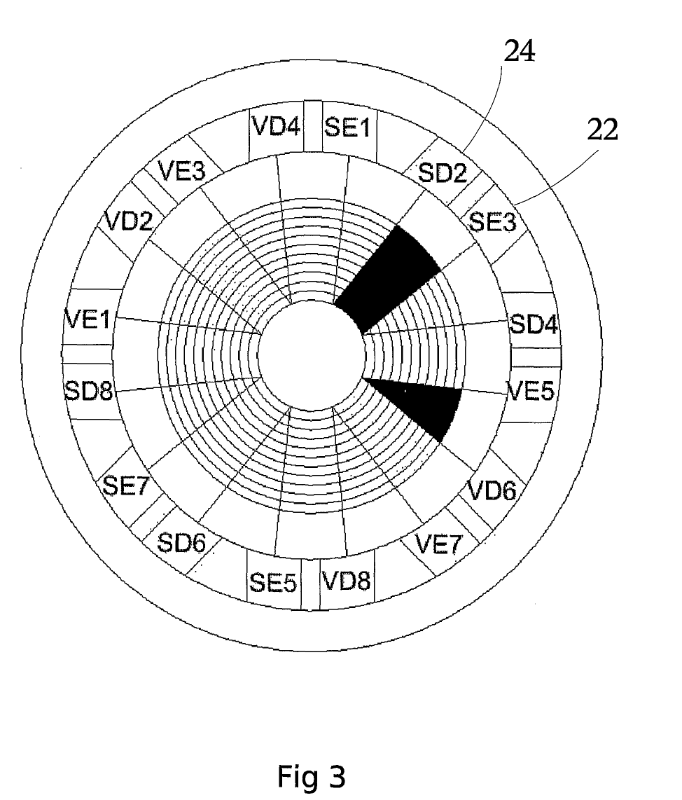

FIG. 3 is a diagram illustrating a sensor array suitable for use in embodiments of the invention;

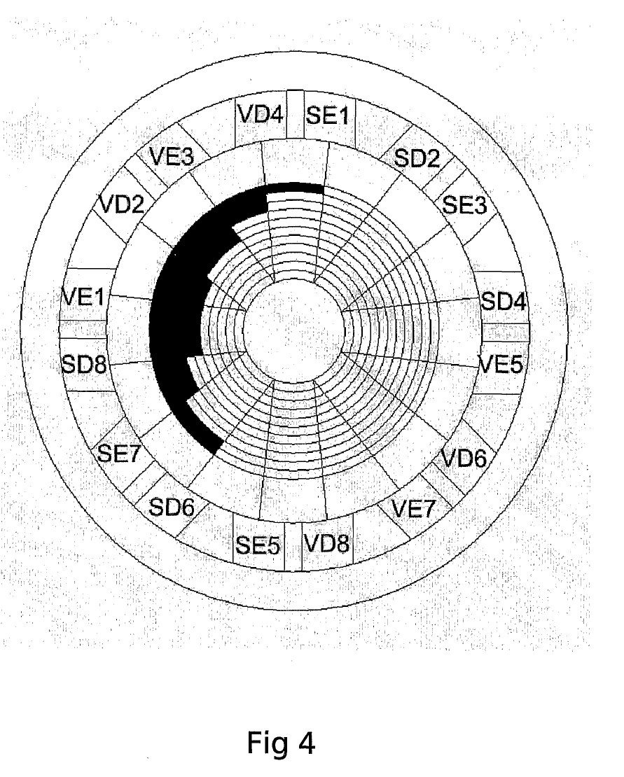

FIG. 4 is a diagram that illustrates occupation of hypothetical segments of a sensor chamber in an embodiment of the invention;

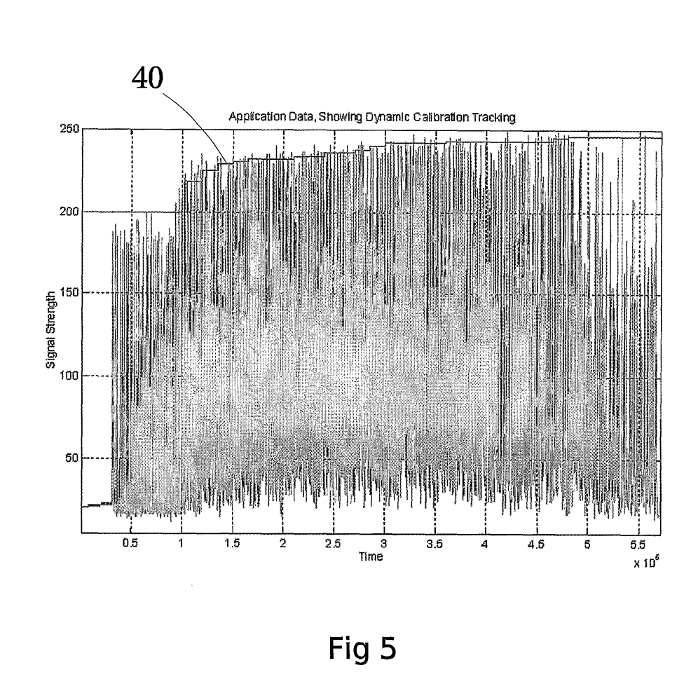

FIG. 5 is a graph that illustrates output from detectors in a sensor array embodying the invention to show a method of calibration of the display; and

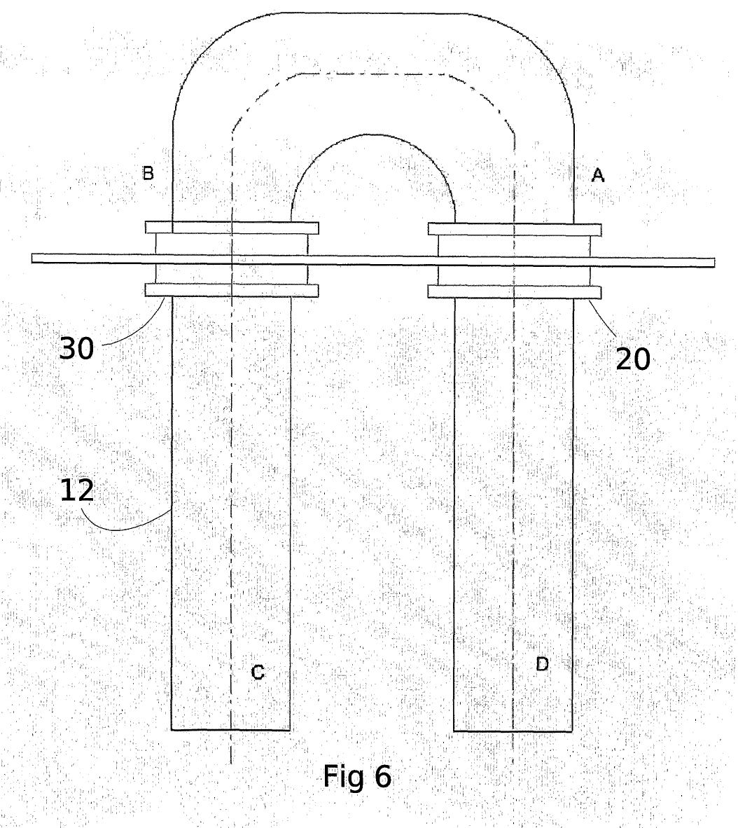

FIG. 6 is a view of a duct and measuring chamber of a flow meter being a second embodiment of the invention.

With reference first to FIG. 1, a section of the path followed by fluid flowing in a flow meter is shown. This embodiment is intended to measure the volume flow of milk emerging from a milking machine. This flow comprises slugs of highly aerated milk that appear at irregular intervals, the slugs being separated by volumes of air within which milk is liquid milk is dispersed as an aerosol.

To determine volume flow, two values are measured: the instantaneous cross-sectional area (CSA) occupied by flowing liquid and the velocity of the liquid in a direction normal to the plane in which the CSA is measured. The scalar product of these two measured values is the volume flow rate.

In this embodiment, the sensor chamber and the feed duct are formed as a one-piece glass tube 10 which will be referred to as the measuring tube. The measuring tube 10 is formed to have a generally inverted U shape, the tube being disposed generally vertically. The portion of the measuring tube that constitutes a feed duct comprises a straight vertical section 12 that runs into an inverted U-shaped section 14. The sensor chamber is a straight vertical section 16 that runs from the U-shaped section 14.

Fluid enters the measuring tube at point C in a slug or semi-slug formation, which may be populating the full CSA of the tube or only part of the CSA. The fluid is transported up into the U-shaped section 14 as a result of the pressure differentials in the system, which is under vacuum pressure.

FIG. 2 illustrates the progress of two slugs of milk as they pass through the measuring tube 10. as has been discussed, the slug contains components that are fast-moving and components that are slow-moving. Slow-moving components may have insufficient energy to climb high enough to pass through the U-shaped section 14. Those components that have just sufficient energy to pass through the U-shaped section 14 will tend to cling to the inside of the curve of the U-shaped section 14, shown at 32. This will be referred to as the “residual flow”. Fast-moving liquid will be concentrated at the outside of the curve of the U-shaped section 14.

As the slug of fast-moving liquid travels through the feed duct to enter the U-shaped section 14, its general direction of travel is turned through 180°, to enter the sensor chamber 16 travelling generally vertically downwards. To achieve this change in direction, a centripetal force is applied by the outer wall of the U-shaped section 14 to the fluid travelling through it. This causes the liquid to be compressed towards the outside surface, in the region indicated as B in FIG. 1 and at 34 in FIG. 2. This compression affects the flow in several ways. It causes the fluid to be compressed, thereby encouraging separation of the liquid from the accompanying air. It also tends to cause the liquid in the slug to move as a body at a common velocity.

A sensor array 20 is positioned at region E in FIG. 1. At this stage, the liquid is travelling generally downwardly (at 36). At this stage of its travel, the high-speed components are still showing a preference for the outside surface B. (Note that this tendency is diminished as the liquid continues to flow downwardly, so it is advantageous to position the sensor array as close as is practicable to the U-shaped section 14.

This is the region at which the velocity and CSA measurements are made. From this region onwards, the liquid mass consisting, which typically includes separated components at varying velocities, will start to distribute the liquid mass more uniformly around the sensor chamber, making it difficult to identify and measure.

Having outlined the general principle of operation of this embodiment, some consideration will now be given as to how it may be optimised.

Ideally the liquid would be transported through the sensor chamber 16 in a complete unified formation, but in practice this does not usually happen. During the latter period of transport, the unified mass will start to disintegrate and components of varying momentum will continue to be transported. Some components will lack the necessary momentum to travel round the U-shaped section 14 in the wake of the main mass component and will stop and change direction. Other components will travel through the U-shaped section 14 at reduced velocities and will favour the inside surface on the downward path D (at 26 in FIG. 2).

As a result of the above dynamics the following characteristics are achieved:
Fluid mass travelling at different velocities are separated
The fluid mass travelling at speed is forced to travel along a particular surface where its velocity can be more readily measured by multi-layer reflection or transmission technologies.
The design ensures that more full-pipe scenarios occur facilitating a dynamic calibration tracking system. That is to say, the liquid tends to flow in slugs that occupy substantially the entire CSA of the sensor chamber 16.
Effective compression of the milk may reduce the presence of air bubbles in the fluid reducing the likelihood of inaccurate readings.

With reference to FIG. 3, operation of one sensor array suitable for use in embodiments of the invention will now be described in detail.

The array comprises two similar rings of emitters and detectors, centred upon the central axis of the sensor chamber, and spaced along the axis of the sensor chamber, in this embodiment, the spacing being approximately 5 mm. Each ring includes eight emitters 22 (all having odd numbers in FIG. 3) and eight corresponding detectors 24 (all having even numbers in FIG. 3). Each emitter is associated with two detectors: a primary detector and a secondary detector. In operation, the detector can generate a signal that depends upon the amount of radiation from the emitter that is reflected by the contents of the liquid within the sensor chamber 16.

To achieve a measurement of cross-sectional area occupied by liquid, the flow-meter sensor chamber is hypothetically segmented, as shown in FIG. 3. The area is divided up into a series of annuli. During any instant, none, some or all of the segments are occupied by liquid, the CSA being calculated by addition of the areas of all of the occupied segments. These represent the depth measurements that will be recorded during the initial calibration and sensor chamber mapping process. The CSA is further subdivided into sectors representative of a particular detector's field of view. There are both primary and secondary sectors relating to there respective operation of an emitter in combination, respectively, with its associated primary and secondary detector.

Measurement of velocity can be made with the same array. The distance between the two rings is known, so the time taken for liquid to pass between them can be used to calculate the speed of the liquid. Speed measurement is advantageously performed at region B of the measuring chamber. As a slug of liquid passes into range of the detector array 20, it creates a very well-defined step change in its output. The interval between such a step change being detected in subsequent rings of detector can be measured with little ambiguity, and from that time measurement, speed can be calculated.

During commissioning of the detector array, a mapping is calculated between the emitters and the detectors. During the mapping process, measurements are taken from each detector and receiver pair as incremental annuli are filled with a test sample of liquid. This can be achieved by placing a cylindrical, non-reflective body within the centre of the measuring chamber. These measurements are recorded and used to calculate the number of populated segments for the corresponding sector of each array.

During measurement, pairs of emitters and detectors are activated sequentially to determine which of the segments are occupied by liquid and which are unoccupied. This is illustrated in FIG. 4, occupies segments being shown in black. (Note that the view in FIG. 4 is directed axially upwardly within the sensor chamber 16.) Segments that are shown in black can are those that are occupied by liquid. Since the area of each segment is known and fixed, the CSA of the liquid is the sensor chamber 16 can be calculated by summation of the areas of each occupied segment.

An optical sensor system such as those disclosed above, when used in a practical application, is vulnerable to changes in its effective calibration settings. This may arise as a result of environmental changes to the measurement devices and associated electronics, as a result of compositional variations in the measurement medium (e.g., milk fat content), or for many other reasons. Therefore, the control system employed in this embodiment includes a calibration tracking system to detect and compensate for such variations.

The embodiment is configured such that each detector 24 within the array 20 will frequently encounter a saturation or near-saturation condition, for instance during the passage of a slug of milk. Further, the characteristics of each array are individually recorded and mapped to a specified calibration value at their point of saturation.

The control software includes a statistical based calibration tracking routine that monitors each individual array and produces a tracking parameter. This value is updated every few seconds and used to adjust internal lookup tables proportionally in respect of any general deviations from the initial calibration. This aspect of the flow measurement system significantly reduces or eliminates errors.

FIG. 5 illustrates the output from a detector installed in a milking installation over the course of a milking session. The tracking parameter is indicated by line 40. This parameter represents the approximate maximum value of the output from the detector—that is to say, the output that can be expected in a condition of saturation. This can provide a datum against which other output levels of the detector can be compared.

This embodiment is configured such that the tracking parameter does not decrease. If it were to so do, the calibration may be upset towards the milking session when the milk flow decreases and can no longer cause the detector to saturate.

An alternative embodiment is shown in FIG. 6. This embodiment can provide an improvement in accuracy albeit at greater cost. This embodiment has a secondary sensor array 30 upstream of the primary array 20. The embodiment of FIG. 6 is a modification of the embodiment of FIG. 1. In this embodiment, the secondary array 30 measuring array to the inlet section 12 of the measuring tube 10 shortly in advance of the U-shaped section 14. As a slug of liquid travels, up the inlet section 12, driven by a differential in pressure of air flowing within the tube 10, fragmentation of the liquid structure may occur and a number of flow components will be present: the flow will become multiphase. Making a velocity measurement of the main components of the flow and its approximate volume/mass ratio at region A (in FIG. 6) will allow for multiple predictive calculations to be processed, for example by using Bernoulli's equations.

One such component is a secondary residual flow component. This flow component, which travels along the wall of the measuring tube 10, is propelled by interaction with frequent flow slugs, and is affected by friction with the wall of the measuring tube 10 and by gravity. By calculating its maximum upward velocity at point A of the residual flow, in respect of its interaction with the main flow, the general velocity of the residual flow at point B may be estimated.

1. A volume flow meter for measuring volume flow of a multiphase fluid comprising: a sensor chamber; a feed duct for conveying fluid to the sensor chamber; wherein the feed duct is shaped such that the fluid leaving the feed duct has a character that is more nearly in a pure liquid phase than the fluid entering the feed duct.

2. A volume flow meter according to claim 1 in which the feed duct is shaped as a U.

3. A volume flow meter according to claim 2 in which the U is disposed in a vertical plane with the convex outer surface uppermost.

4. A volume flow meter according to any preceding claim in which reduction in the multiphase nature of the flow is achieved by causing the flow to follow a curved path, centripetal force applied by the wall of the duct to the flow causing the fluid to compress against the outer wall of the duct.

5. A volume flow meter according to any preceding claim in which, from the feed duct, fluid passes downwardly into a generally vertical sensor chamber.

6. A volume flow meter according to any preceding claim further including a metering arrangement that detects and measures fluid flow through the sensor chamber.

7. A volume flow meter according to claim 6 in which the metering arrangement operates to detect flow using optical detection means.

8. A volume flow meter according to claim 6 or claim 7 in which the measuring chamber is formed of a transparent material.

9. A volume flow meter according to any one of claims 6 to 8 in which the metering arrangement operates by directing radiation through the tube and detecting reflection of radiation from the fluid within the tube.

10. A volume flow meter according to claim 9 in which the metering arrangement operates principally by detection of multi-layered reflection from liquid within the sensor chamber.

11. A volume flow meter according to any preceding claim further comprising a secondary sensor chamber, fluid flowing through the meter first passing through the secondary sensor chamber, then into the feed duct, and then into the primary sensor chamber.

12. A volume flow meter for measuring volume flow of a multiphase fluid comprising a primary sensor array and a secondary array chamber, the fluid to be measured passing through the secondary sensor array before passing through the primary sensor array, output from the first sensor array being analysed and the results of the analysis being used to influence operation of the primary sensor array.

13. A volume flow meter according to claim 12 in intended to measure flow that occurs in slugs, output from the secondary sensor array being used to detect the imminent arrival of a slug, such that the primary sensor array can be configured to operate in a mode most suitable for measurement of flow in a high-flow conditions immediately prior to the arrival of a slug at the primary sensor array.

14. A volume flow meter according to claim 12 or claim 13 in which the secondary sensor array is operative to measure velocity of flow passing through it.

15. A volume flow meter according to any one of claims 12 to 14 in which the secondary sensor array is operative to determine an estimate of the mass/volume ratio of fluid flowing through it.

16. A method for calibration of a sensor array used in measurement of flowing fluids, in which the array includes one or more emitters and one or more detectors, each detector being operative to measure radiation emitted by an emitter that has been reflected from flowing fluid, in which it is assumed that, during operation, the detectors will from-time-to-time receive an amount of reflected radiation corresponding to maximum flow in the pipe, the method comprising maintaining a tracking parameter that represents the maximal output from the detector as it changes with time.

17. A method for calibration according to claim 16 in which the tracking parameter may be the instantaneous maximum output that has been observed in a measurement session.

18. A method for calibration according to claim 16 or claim 17 applied to calibration of an optical sensor array.

19. A method for calibration according to any one of claims 16 to 18 in which the parameter is allowed only to rise (or remain steady).
